(19) United States
(12) Patent Application Publication
(10) Pub. No.: US 2017/0288286 A1
(43) Pub. Date: Oct. 5, 2017

(54) LIQUID TEMPERATURE REGULATED BATTERY PACK FOR ELECTRIC VEHICLES

(71) Applicant: Faraday&Future Inc., Gardena, CA (US)

(72) Inventors: Kameron Fraige Saad Buckhout, Inglewood, CA (US); John Henry Harris, III, San Gabriel, CA (US)

(21) Appl. No.: 15/261,434

(22) Filed: Sep. 9, 2016

Related U.S. Application Data
(60) Provisional application No. 62/317,137, filed on Apr. 1, 2016.

(51) Int. Cl. H01M 10/6568; H01M 2/30; H01M 10/0525; H01M 10/613; H01M 10/625; H01M 2/10; H01M 2/20

(52) U.S. Cl. CPC H01M 10/6568; H01M 2/1077; H01M 2/305; H01M 2/206; H01M 10/613; H01M 10/625; H01M 10/0525; H01M 2220/20

(57) ABSTRACT

Systems and methods for liquid temperature regulated energy storage for electric vehicles are disclosed. Systems can include a tray configured to receive a plurality of battery housings and having a bottom surface for supporting the plurality of battery housings from below. A liquid path can be spaced away from the bottom surface and above the battery housings when the housings are inserted into the tray. The liquid path can have an inlet flow path with a plurality of outlets coupleable to an inlet in at least one flow path in the plurality of battery housings and an outlet flow path with a plurality of inlets coupleable to an outlet in the at least one flow path in the plurality of battery housings. A circuit can be configured to provide a voltage difference between the tray and a positive terminal.

### RELATED APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Application No. 62/317,137, filed Apr. 1, 2016, entitled “LIQUID TEMPERATURE REGULATED BATTERY PACK FOR ELECTRIC VEHICLES.” This application is also related to attorney docket number FARA.059A1, filed on the same day as the present application, and also claiming priority to U.S. Provisional Application No. 62/317,137. Each of the above-identified applications are hereby incorporated by reference in their entirety.

### TECHNICAL FIELD

The present disclosure is related to battery systems have adjustable energy storage capabilities. More particularly, a liquid temperature regulated battery pack configured to receive additional modular battery packs is disclosed herein.

### BACKGROUND

Large lithium ion battery packs require that the individual battery cells within them be regulated in temperature during operation. Such battery packs may employ a cooling system having air cooled heat sinks (passive airflow or fan assisted). Other cooling systems use liquid cooling where the batteries are immersed in a liquid coolant and is circulated around the batteries. The liquid can also be heated to warm the batteries.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description of the Preferred Embodiments” one will understand how the features of the system and methods provide several advantages over traditional systems and methods.

In one embodiment, a modular low voltage battery pack for a vehicle is described. The battery pack includes a tray configured to receive a plurality of battery housings, a liquid path spaced away from the bottom surface and above the battery housings when the housings are inserted into the tray, and a circuit configured to provide a voltage difference between the tray and a positive terminal. The tray has a bottom surface for supporting the plurality of battery housings from below. The liquid path has an inlet flow path with a plurality of outlets coupleable to an inlet in at least one flow path in the plurality of battery housings and an outlet flow path with a plurality of inlets coupleable to an outlet in the at least one flow path in the plurality of battery housings.

The tray may include a plurality of receiving spaces separated by upwardly extending walls, each receiving space configured to receive one or more battery housings. The liquid path may include a substantially straight conduit extending from the inlet flow path and terminating at a distalmost outlet coupleable to a distalmost inlet in at least one flow path in the plurality of battery housings. The liquid path may include a substantially straight conduit extending from the proximalmost inlet flow path and terminating at a proximalmost outlet coupleable to a proximalmost outlet in at least one flow path in the plurality of battery housings. The circuit may include a parallel bus bar configured to electrically connect at least two terminals on the top side of each of the battery housings.

The battery pack may further include the plurality of battery housings disposed within the tray. Each battery housing of the plurality of battery housings may include a common flow channel in thermal contact with non-electrically conductive portions of two sets of electrochemical cells. The common flow channel may extend in a direction that is normal to the bottom surface of the tray. The electrochemical cells may be cylindrical battery cells that are oriented normal to the flow channels within each battery housing. The electrochemical cells in each housing may be connected by two circuits on opposite sides of the flow channel, the circuits being positioned parallel to the flow channel.

In another embodiment, a method of adding a battery module to a modular low voltage battery pack of a vehicle is described. The method includes disconnecting a bus bar from a terminal post of a first battery module secured within a tray of the battery pack, uncoupling a coolant conduit from a coolant inlet of the first battery module, placing a second battery module into the tray, electrically connecting the bus bar to the terminal post of the first battery module and a terminal post of the second battery module, and coupling the coolant conduit to the coolant inlet of the first battery module and a coolant inlet of the second battery module. Adding the second battery module to the battery pack increases the energy storage capacity of the battery pack.

The first battery module and the second battery module may be electrically connected in parallel. Adding the second battery module to the battery pack may not increase the maximum open circuit voltage of the battery pack. The method may further include placing a third battery module into the tray, securing the third battery module to the tray, electrically connecting the bus bar to the terminal post of the third battery module, and coupling the coolant conduit to the coolant inlet of the third battery module.

In another embodiment, a modular low voltage battery pack for a vehicle is described. The battery pack includes at least one battery module having a positive terminal post, a coolant inlet, and a coolant outlet, circuitry configured to electrically connect the positive terminal post to a low voltage vehicle load, a cooling system configured to supply coolant to the at least one battery module at the coolant inlet and receive coolant from the at least one battery module at the coolant outlet, and a tray secured to and at least partially surrounding the at least one battery module. The cooling system comprises at least one conduit. The tray is configured to receive at least one additional battery module to increase the energy storage capacity of the battery pack.

The circuitry may include a conductive metallic bus bar configured to be removably electrically connected to one or more positive terminal posts. The bus bar may include a plurality of apertures, each aperture sized and shaped to receive the positive terminal post of a battery module. Each battery module may further include a negative terminal post, at least a portion of the tray may include an electrically conductive metal, and the negative terminal post of each of the plurality of battery modules may be electrically connected to the electrically conductive metal. The cooling system may be configured to supply coolant to the at least one additional battery module at a coolant inlet and receive coolant from the at least one additional battery module at a coolant outlet.

The cooling system may include a coolant supply conduit having a plurality of fluid supply connectors and a coolant return having a plurality of fluid return connectors. Each fluid supply connector may be configured to be removably connected to a coolant inlet. Each fluid return connector may be configured to be removably connected to a coolant outlet. Each fluid supply connector may be configured to prevent coolant from flowing out of the coolant supply conduit while not connected to a coolant inlet. Each fluid return connector may be configured to prevent coolant from flowing out of the coolant return conduit while not connected to a coolant outlet.

### BRIEF DESCRIPTION OF THE DRAWINGS

The following is a brief description of each of the drawings. From figure to figure, the same reference numerals have been used to designate the same components of an illustrated embodiment. The drawings disclose illustrative embodiments and particularly illustrative implementations in the context of connecting a plurality of electrochemical cells. They do not set forth all embodiments. Other embodiments may be used in addition to or instead. Conversely, some embodiments may be practiced without all of the details that are disclosed. It is to be noted that the Figures may not be drawn to any particular proportion or scale.

FIG. 1 is a schematic illustration of an electric vehicle having two battery systems according to an exemplary implementation. As shown, the first battery system powers one or more high voltage loads and the second battery system powers one or more low voltage loads.

FIG. 2 is a left-side perspective view of an exemplary implementation of a battery housing. As shown, the housing may include a plurality of substantially cylindrical electrochemical cells.

FIG. 3 is a right-side perspective view of the housing of FIG. 2 with the cell retaining wall removed.

FIG. 4 is a perspective view of the battery housing of FIG. 2 with the cell cover walls removed.

FIG. 5 is a cross-sectional view of FIG. 2 about the line 5-5.

FIG. 6 is a cross-sectional view of FIG. 2 about the line 6-6.

FIG. 7 is a cross-sectional view of FIG. 2 about the line 7-7.

FIG. 8 in an exploded perspective view of the housing of FIG. 2.

FIG. 9 is an exploded perspective view of the channel assembly.

FIG. 10 is a perspective view of the assembled channel assembly of FIG. 9.

FIG. 11 is a perspective view of an exemplary configuration of a battery housing including battery connection circuitry.

FIG. 12A is a schematic diagram illustrating an exemplary implementation of a cooling system for an electric vehicle.

FIG. 12B is a schematic diagram, similar to FIG. 11A, illustrating another exemplary implementation of a cooling system for an electric vehicle.

FIG. 13 is a perspective view of the battery housing of FIG. 11 with a bus bar connecting the two battery module parts in series.

FIG. 14 is a perspective view of a tray configured to receive a plurality of battery housings.

FIG. 15 is a perspective view of the tray of FIG. 14 containing a plurality of battery housings as depicted in FIG. 13.

FIG. 16 is a perspective view of the system of FIG. 15 with a parallel bus bar connecting the battery housings to an external electrical connection.

FIG. 17 is a perspective view of the system of FIG. 16 with coolant conduits connected to the battery housings.

FIG. 18 is an exploded view of the system of FIG. 17.

### DETAILED DESCRIPTION OF THE PREFERRED EMBODIMENTS

Disclosed herein is battery pack having at least one cooling channel disposed therein. The cooling channel may be formed by two cooling plates that are spaced apart by a gap. The cooling plate may form a wall of an enclosure. The remaining walls of the enclosure may be formed of material that is not as thermally conductive as the cooling plate. For example, the cooling plate may include aluminum and the remaining portions of the enclosure may include a plastic. The enclosure may house a plurality of electrochemical cells, such as, for example, lithium ion battery cells. Other types of electrochemical cells are also contemplated. Liquid coolant may be circulated through the channel. Thus, the channel may have an inlet and an outlet and the liquid coolant may flow from the inlet to outlet. In some aspects the channel includes a flow divider. The fluid may be configured to flow in a U-shape-like path from the inlet to the outlet.

Typical electric vehicles almost exclusively draw their power from one high capacity, high voltage battery system. The high capacity, high voltage battery system is used to power the motors that propel the vehicle and is stepped down with one or more DC-DC converters to power other electrically powered systems. When the high capacity, high voltage battery system is not engaged, for example, when the vehicle is parked, a lower capacity, lower voltage battery may be relied upon. This second battery may function as a typical automobile battery and may be used to start the vehicle and power other components such as, for example, the windows, door locks, and stereo when the high capacity, high voltage battery is disengaged. The second battery is typically recharged by the high capacity, high voltage battery when the vehicle is driving and/or when the high voltage battery system is engaged.

The high voltage battery system may be configured to power the vehicle components that require relatively high voltages. For example, the high voltage battery system may be configured to power one or more electric motors that are used to propel the vehicle. The low voltage battery system may be configured to power the vehicle components that require relatively lower voltages in comparison to the high voltage battery system. For example, the low voltage battery system may be configured to power the cabin HVAC system(s), the windows, the locks, the doors, the audio and entertainment systems, infotainment systems, wireless modems and routers, touch screens, displays, navigation systems, automated driving systems, and the like. Low voltage systems or components may generally refer to systems or components that require less voltage than the motors that propel the vehicle.

A vehicle with at least two separate high capacity energy storage systems can have several advantages. For one, the low voltage system can power vehicle systems for long periods of time without engaging the high voltage battery system. Energy is lost when electric power is moved between battery systems. For example, DC-DC converters are not perfectly efficient and energy is lost when a DC-DC converter is operated. Thus, if the low voltage system has sufficient storage capabilities, it can be used to power systems other than the propulsion motors for longer periods of time and the need for recharging the low voltage system and/or the need to draw power from the high voltage system, may be reduced or eliminated.

A relatively high capacity, low voltage battery may require a heating and/or cooling system. At very low temperatures, the electrochemical cells in the high capacity, low voltage battery pack may not be capable of powering the required loads. High temperatures may cause battery failure and/or fire.

The following description is directed to certain implementations for the purpose of describing the innovative aspects of this disclosure. However, a person having ordinary skill in the art will readily recognize that the teachings herein can be applied in a multitude of different ways.

As used herein, the term “electric vehicle” can refer to any vehicle that is partly or entirely operated based on stored electric power, such as a pure electric vehicle, plug-in hybrid electric vehicle, or the like. Such vehicles can include, for example, road vehicles (cars, trucks, motorcycles, buses, etc.), rail vehicles, wheeled robots, or the like.

In some implementations, the word “battery” or “batteries” will be used to describe certain elements of the embodiments described herein. It is noted that “battery” does not necessarily refer to only a single battery cell. Rather, any element described as a “battery” or illustrated in the Figures as a single battery in a circuit may equally be made up of any larger number of individual battery cells and/or other elements without departing from the spirit or scope of the disclosed systems and methods.

Reference may be made throughout the specification to a “12 volt” power systems or sources. It will be readily apparent to a person having ordinary skill in the art that the phrase “12 volt” in the context of automotive electrical systems is an approximate value referring to nominal 12 volt power systems. The actual voltage of a “12 volt” system in a vehicle may fluctuate as low as roughly 4-5 volts and as high as 16-17 volts depending on engine conditions and power usage by various vehicle systems. Such a power system may also be referred to as “low voltage” battery systems. Some vehicles may use two or more 12 volt batteries to provide higher voltages. Thus, it will be clear that the systems and methods described herein may be utilized with low voltage battery arrangements in at least the range of 4-34 volts without departing from the spirit or scope of the systems and methods disclosed herein.

The present disclosure may be implemented to achieve one or more advantages other traditional battery cooling systems. In some aspects, the amount of coolant that is required is minimized. For example, by utilizing the disclosed geometry, the channel can allow the liquid to cool two physically separated sets of battery cells at the same time.

In certain aspects, the present system may be less expensive to manufacture than previous systems. For example, certain aspects achieve the desired heat conduction properties while primarily relying on components made of low cost plastics. Manufacturing time may also be reduced and/or simplified. For example, two halves of the housing may be substantially similar and include only one conductive surface each. These two halves may be joined in one step to form a cooling channel in between the two halves.

Such enclosures can also be configured as modular battery packs having the desired electrical characteristics. The modular packs may be added and/or removed as needed. For example, if a user desires extra battery lifetime, additional packs may be easily added to the system. In some aspects, the modular packs may be connected to a cooling system that is also used to cool/heat the higher voltage batteries that are used to power the vehicles propulsion motors and/or drivetrain. Thus, additional pumps, fans, heat exchangers, and the like may not be required. In some aspects, the inlet and the outlet for coolant are located on the same side of the housing such that connection to coolant lines is simplified. In some implementations, the outlet is located at a high point such that air bubbles may be more readily expelled from the coolant path.

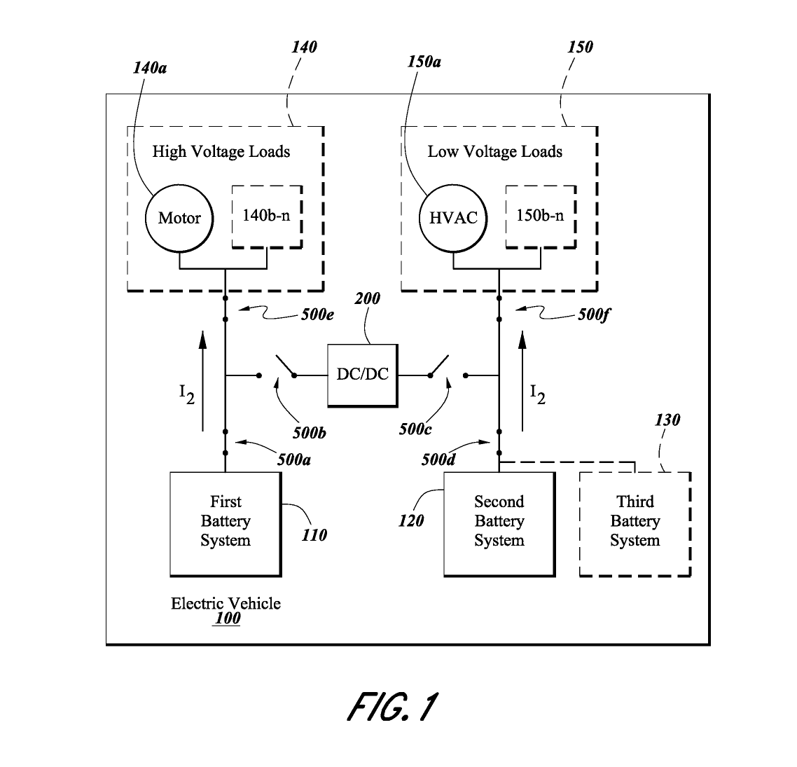

FIG. 1 schematically illustrates an electric vehicle 100 having a first battery system 110 and a second battery system 120. The first battery system 110 may be electrically connected to one or more high voltage loads 140. The first battery system 110 may include one or more batteries connected in series and/or in parallel. The first battery system 110 may be controlled by one or more battery controllers or battery control systems (not shown). Such controllers may include circuitry capable of regulating and/or controlling the available voltage differences and/or current.

The one or more high voltage loads 140 may include an electric motor 140a. The electric motor 140a may be configured to propel the vehicle 100. The electric motor 140a may be an interior permanent magnet motor. One or more inverters may also be provided. It should be appreciated that while the motor 140a is an electrical machine that can receive electrical power to produce mechanical power, it can also be used such that it receives mechanical power which it converts to electrical power. Additional loads 140b-n may also be electrically connected to the first battery system 110. The additional loads 140b-n may include, for example, additional motors, power train components, and the like.

As shown in FIG. 1, current I₁ from the first battery system 110 may flow to the one or more high voltage loads 140. That is to say, the first battery system 110 may power the one or more high voltage loads 140a-n. A switch 500b in the open position is shown between the first battery system 110 and a DC/DC converter 200. Thus, current I₁ does not flow from the first battery system 110 to the one or more low voltage loads 150a-n nor to a second battery system 120.

The second battery system 120 may be electrically connected to one or more low voltage loads 150. The second battery system 120 may include one or more batteries connected in series and/or in parallel. The second battery system 120 may be controlled by one or more battery controllers (not shown).

The one or more low voltage loads 150 may include an HVAC 150a. The HVAC 150a may be configured to heat, cool, and/or circulate air through the vehicle's passenger cabin. The HVAC 150a may include various types of heating, cooling, and ventilation components. For example, the HVAC 150a may include one or more heating elements, seat heaters, floor heaters, defrosters, deicers, fans, filters, air conditioners, compressors, and the like.

Additional loads 150b-n may also be electrically connected to the second battery system 120. The additional loads 150b-n may include, for example, additional motors (e.g. for windows, door locks, sun roofs, compartments), audio system components, infotainment system components, computers, navigation system components, mobile phones, electrical outlets, refrigerators, and the like. A battery management system (not shown) may also be used to regulate the voltage/current that is supplied to the one or more low voltage loads 150a-n.

As shown in FIG. 1, current I₂ from the second battery system 120 may flow to the one or more low voltage loads 150a-n. That is to say, the second battery system 120 may power the one or more low voltage loads 150a-n.

A DC-DC converter 200 may be used to connect the first and second battery systems. Switches 500a-e may be provided. A switch 500c in the open position is shown between the second battery system 120 and the DC/DC converter 200. Thus, current I₂ does not flow from the second battery system 120 to the one or more high voltage loads 140a-n nor to the first battery system 110. While switches 500a-e are shown in FIG. 1, other control mechanisms may be used. Current controllers and/or battery controllers and/or DC-DC converter controllers may be utilized to control which battery system(s) is (are) utilized. The DC-DC converter 200 may be a bidirectional DC-DC converter.

In some aspects, the electric vehicle 100 may include a third battery system 130. The battery system 130 may have a capacity that is less than the capacity of both the first and the second battery system. The third battery system 130 may be used to power one or more battery control systems, switches, contactors, essential low voltage components and the like. In some aspects, the third battery system 130 is configured analogously to a standard starting, lighting, and ignition automobile battery. The third battery system 130 may be used, for example, to engage and/or disengage the first and/or second battery systems 110, 120. In some aspects, the third battery system 130 is included in a standard electric vehicle and the second battery system 120 is provided as an add-on feature. The third battery system 130 may be used to power the one or more switches 500a-e. The third battery system 130 may be re-charged by the first 110 and/or second battery system 120.

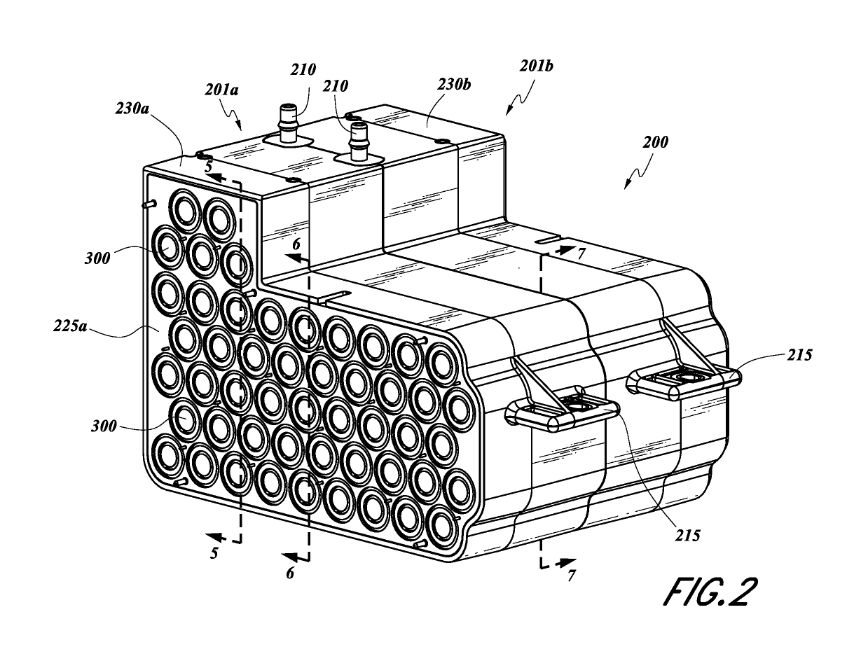

Turning to FIG. 2, a battery housing 200 according to an exemplary implementation is illustrated. FIG. 2 is a left-side perspective view of the housing 200. The housing 200 may be formed by coupling a left housing part 201a with a right housing part 201b. A plurality of electrochemical cells 300 may be placed into the housing 200. In the illustrated embodiment, fifty cells 300 are placed in the left housing part 201a and fifty cells 300 are placed in the right housing part 201b. Thus, the housing 200 includes one hundred total cells 300. However, any number of cells 300 may be included in the housing 200 and/or the housing parts 201a, 201b.

The cells 300 may be cylindrical in shape and have two circular ends that are opposite one another. The side of the cells 300, visible in FIG. 1, may include a positive terminal and a negative terminal disposed thereon. The cells 300 may be electrically connected in parallel and/or in series with circuitry (not shown). For example, each of cells 300 may have a positive terminal and a negative terminal disposed on the outward-facing circular face of the cells 300. A left cell retaining wall 225a may at least partially secure the cells 300 in the left housing 201a. A right cell retaining wall 225b (not shown in FIG. 1) may at least partially secure the cells 300 in the right housing 201b. The cell retaining walls 225a, 225b may be formed of plastic.

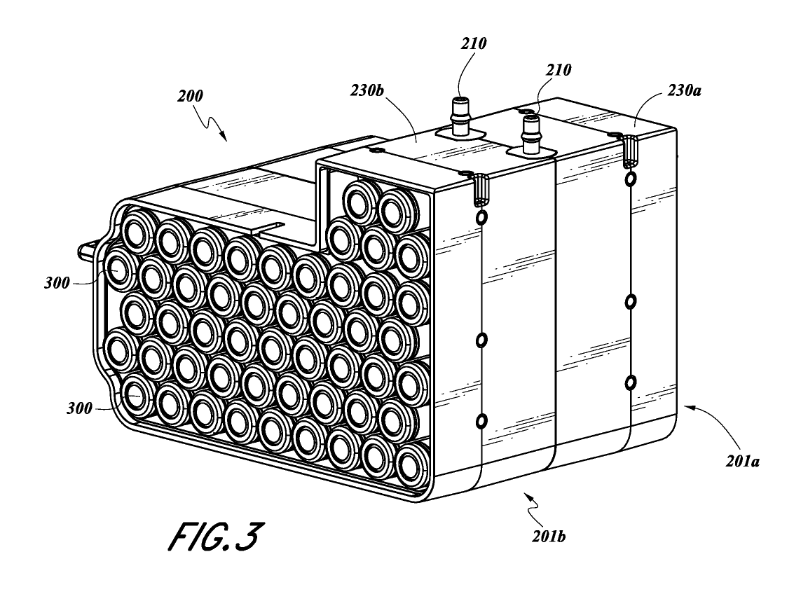

FIG. 3 is a right-side perspective view of the housing 200 with the cell retaining walls 225a, 225b removed. Left and right cell cover walls 230a, 230b may cover the lengthwise portions of the cylindrical cells 300.

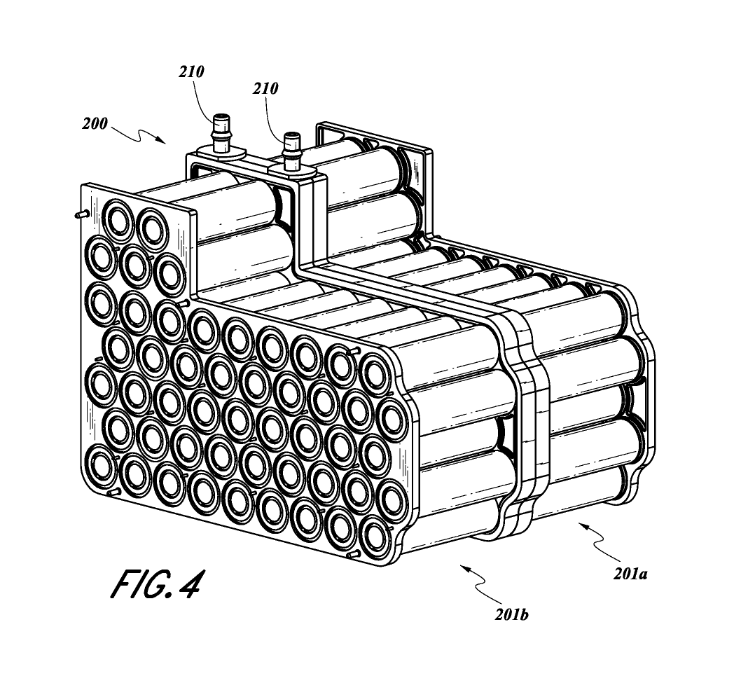

FIG. 4 is a left-side perspective view of the housing 200 with the cell cover walls 230a, 230b removed. The cell cover walls 230a, 230b may be plastic.

Referring again to FIG. 2, brackets 215 may be provided. The brackets 215 may be used to at least partially secure the housing 200 to the vehicle and/or to a subcomponent of the vehicle configured to support a battery housing 200. Coolant inlet/outlets 210, described further below, may be provided on the top side of the housing 200 to permit the ingress and egress of coolant.

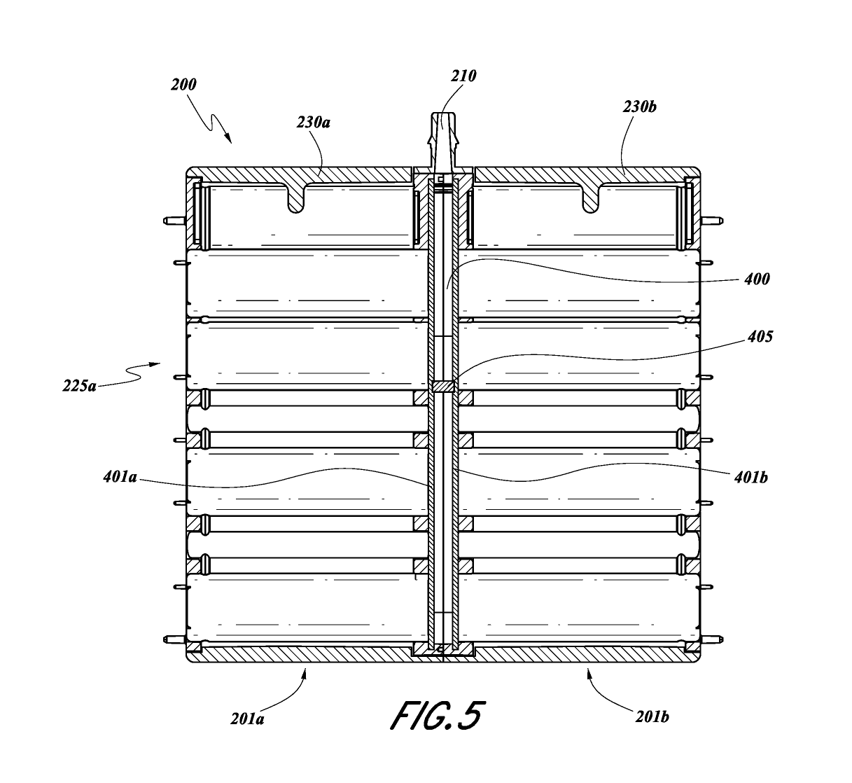

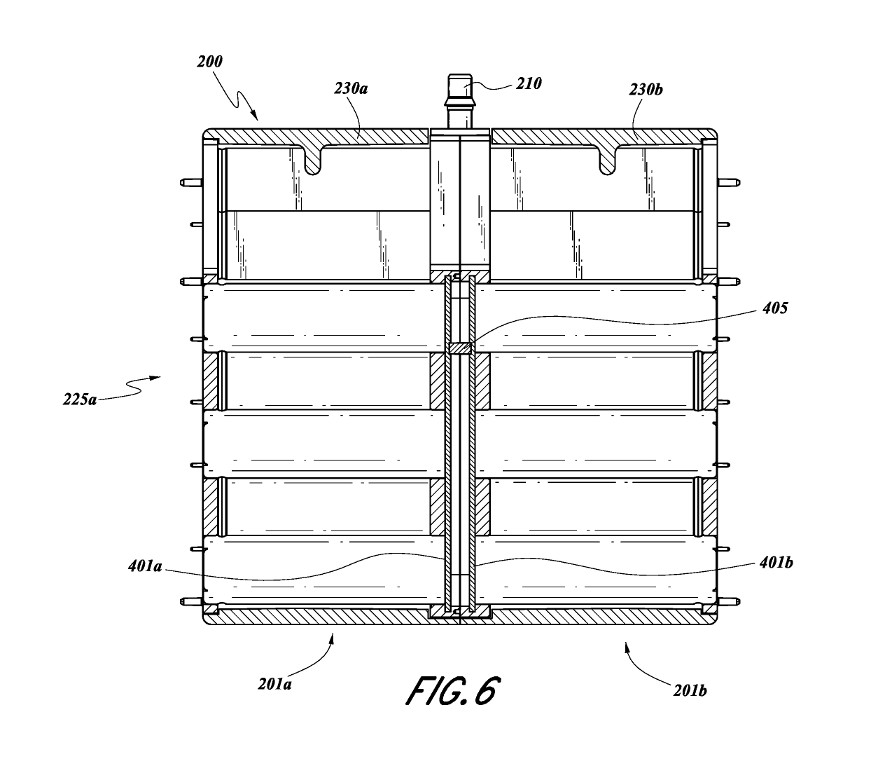

The cross-sectional views in FIGS. 5-6 illustrate that the housing 200 includes a channel 400 disposed therethrough. The channel 400 may be at least partially defined by two thermally conductive plates 401a and 401b. That is to say, the plates 401a and 401b may be spaced apart by a gap. The plates 401a, 401b may be formed of aluminum or any other thermally conductive material, such as another metal. A flow diverter 405 may be disposed within the channel 400. Liquid coolant may be pumped into one of the inlet/outlet 210 and out of the other inlet/outlet 210. The liquid coolant may be any suitable coolant. For example, the liquid coolant may be a dielectric coolant. The coolant may be configured to transfer heat from the plates 401a, 401b to the coolant. In some embodiments, coolant or cooling liquid or cooling fluid may include, for example, one or more of the following: synthetic oil, polyolefin (e.g., poly-alpha-olefin (“PAO”)), ethylene glycol, ethylene glycol and water, and phase change materials (“PCM”).

As will be understood, at least one side of the cells 300 may be placed into thermal contact with the plates 401a, 401b. Preferably, the side of the cell placed into thermal contact with the plates 401a, 401b is the side that is opposite to the side of the cell 300 that includes the positive and negative terminal. The cells 300 may be secured into place with an adhesive. Preferably, the adhesive is an epoxy having a high thermal heat transfer coefficient. In this way, heat generated from the cells 300 may flow from the cells 300 to the plate 401a, 401b and into the coolant that flows through the channel 400. In some aspects, when the temperature of the cells 300 is below the desired operating temperature, the coolant may be heated and heat may flow from the coolant to the plates 401a, 401b in order to heat the cells 300.

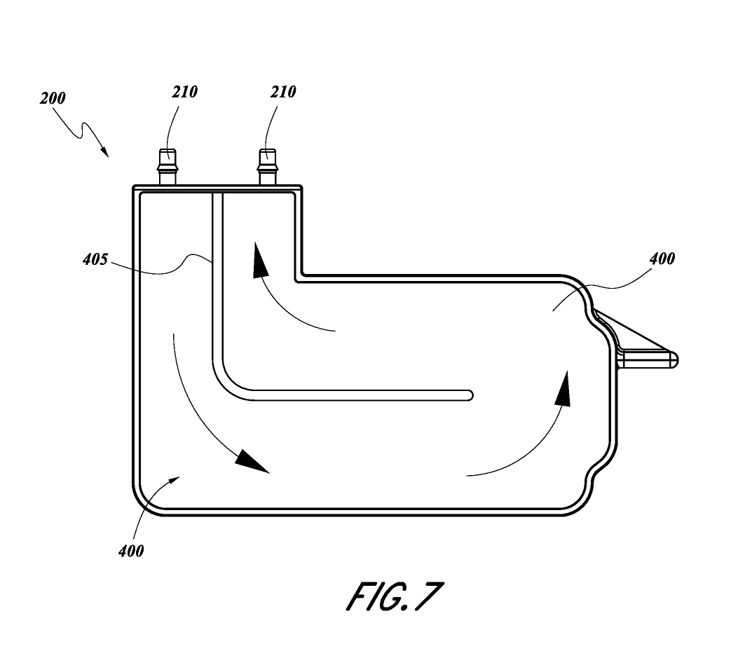

The cross-section view of FIG. 7 illustrates that the coolant may be configured to circulate through the housing 200. For example, the flow diverter 405 in the channel 400 may direct fluid in path from one inlet/outlet 210 to the other inlet/outlet 210. In some aspects, the flow path may include at least one substantially U-shaped bend. While the coolant flow is shown as traveling in the counterclockwise direction, the opposite direction of fluid flow is also contemplated. In some aspects, flowing coolant in the counterclockwise direction may allow for the coolant to warm and thus naturally rise as it moves towards the outlet 210.

The coolant flow configuration depicted in FIG. 7 may also be desirable for the removal of air or other gas pockets, such as bubbles, that may exist within the channel 400. Fluid free areas may form within the coolant, for example, by cavitation and/or by leaks or other points of ingress for air or other gases into the coolant system. Bubbles formed elsewhere in a coolant system may be carried into the channel 400 with coolant liquid entering at an inlet/outlet 210. In some aspects, the counterclockwise coolant flow helps ensure that the coolant is travelling in a generally upward direction as it passes through the u-shaped bend. The buoyant force exerted on bubbles in the channel 400 can combine with the force exerted by the motion of the coolant to more efficiently propel bubbles free of any obstructing structure within the u-shaped bend region of the channel 400 and in the direction of the coolant outlet 210. Similarly, the location of one or both of the coolant inlet/outlet 210 along the topmost surface of the housing 200 may further aid in the removal of fluid-free regions. For example, at least the outlet 210 can be located along the topmost surface of the housing 200 such that the buoyant force exerted on submerged bubbles tends to move the bubbles upward through the channel 400 to the outlet 210, where the bubbles can pass out of the housing 200.

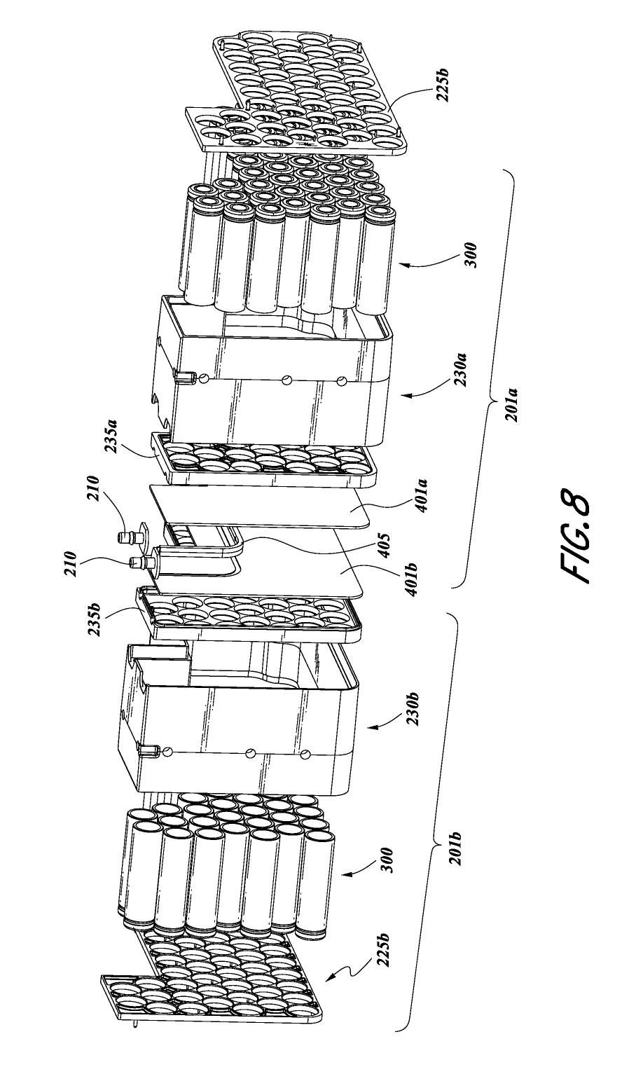

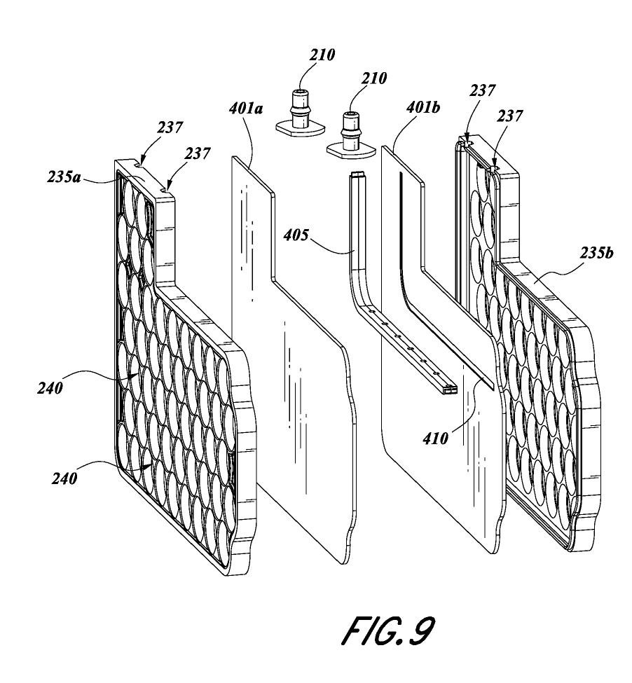

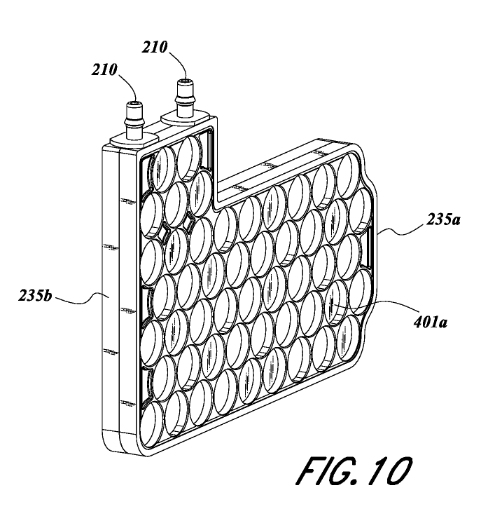

FIG. 8 is an exploded view of the housing 200. As shown, each housing part 201a, 201b may include an outer cell retaining wall 225a, 225b, a cell cover wall 230a, 230b, an inner cell retaining wall 235a, 235b, and a thermally conductive plate 401a, 401b. The cell retaining wall 225a, 225b, cell cover wall 230a, 230b, and inner cell retaining wall 235a, 235b may be formed of a material that is not as thermally conductive as the plate 401a, 401b. For example, these parts may be formed of plastic and the plate 401a, 401b may be formed of metal. In some aspects, two housing halves 201a, 201b are sealed together to form a housing 200 having an internal coolant flow path or channel, as depicted in FIG. 7. The inner cell retaining walls 235a, 235b, plates 401a, 401b, and flow diverter 405 are further detailed in FIGS. 9-10.

The housing may be manufactured according to the following method. While the steps are described in a particular order, other ordering of the steps is possible. FIG. 9 illustrates an exploded view of the channel assembly. The assembled channel assembly is shown in FIG. 10. An inner retaining wall 235a, 235b and plate 401a, 401b may be formed in a single step. For example, the inner retaining wall 235a, 235b may be manufactured using an injection molding process over the plate 401a, 401b. The inner retaining wall 235a, 235b may include a plurality of cell carriers 240. The carriers 240 may be sized and shaped to at least partially receive a portion of a cell 300. The two opposing inner retaining walls 235a, 235b may be secured together such that a gap is formed in between the two plates 401a, 401b. The two opposing inner retaining walls 235a, 235b may be coupled together such that a fluid tight seal is created. The gap between the plates 401a, 401b may form a coolant channel 400.

As shown in FIG. 9, a flow diverter 405 may be inserted into a groove 410 in one or both plates 401a, 401b. The groove 410 may be stamped and or machined into either one or both of the plates 401a, 401b. The flow diverter 405 may be further secured to the plate(s) 401a, 401b with an adhesive. The inner cell retaining walls 235a, 235b may include at least two pre-formed openings halves 237 which can be coupled to the inlet/outlets 210 to form a fluid inlet and a fluid outlet. Coolant may be pumped into the inlet and flowed over the plates 401a, 401b to transfer heat to and/or from the plates 401a, 401b. The coolant may exit an outlet 210.

In other implementations, the cell cover wall 230a, 230b, inner cell retaining wall 235a, 235b, and plate 401a, 401b are formed in a single step. For example, the cell cover wall 230a, 230b, inner cell retaining wall 235a, 235b, and plate 401a, 401b may be formed by injecting molding over a metal plate 401a, 401b. In other implementations, the outer retaining wall 225a, 225b, cell cover wall 230a, 230b, inner cell retaining wall 235a, 235b, and plate 401a, 401b are formed in a single step by injecting molding over a metal plate 401a, 401b.

Cells may be inserted into the cell carriers 240 of the inner retaining walls 235. An adhesive may be used to bond the cells to the plate 401a, 401b and/or the inner cell retaining wall 235a, 235b. The adhesive preferable has a high thermal heat transfer coefficient. The cell carriers 240 and/or the inner retaining walls 235a, 235b may thus form a support for at least a portion of the cells and inhibit the movement of the cells in at least the longitudinal, lateral, and/or transverse direction.

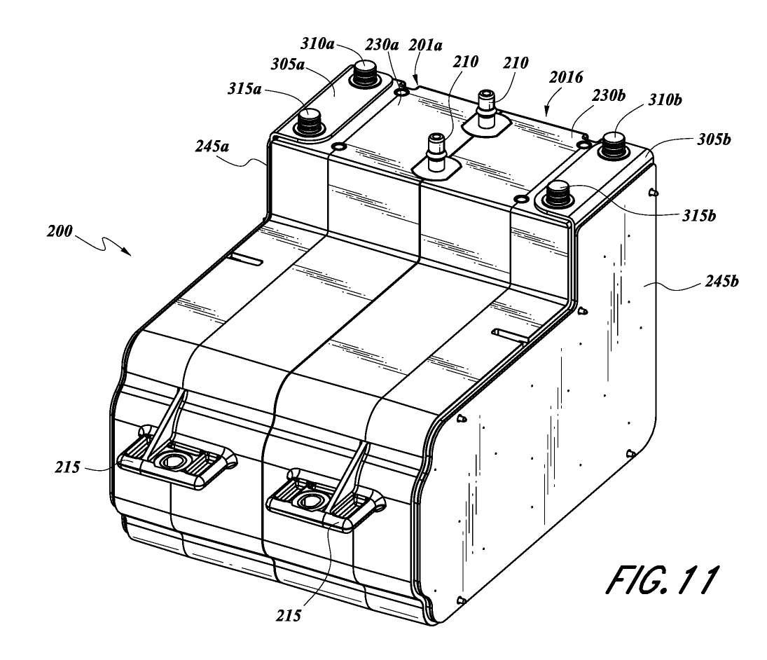

FIG. 11 depicts an assembled battery housing 200 which may include any of the components described above with reference to FIGS. 1-10. The housing 200 includes two parts 201a, 201b, including cell cover walls 230a, 230b. Brackets 215 may be attached to and/or integrally formed as a portion of the cell cover walls 230a, 230b. Coolant may be provided to and removed from the housing 200 at coolant inlet/outlets 210.

Battery cell connection circuits 305a, 305b may be provided to electrically couple the battery cells 300 (not shown in FIG. 11). Cell connection circuits 305a, 305b may include any type of electrical circuitry, such as a printed circuit board, flex circuit, wiring, or other conductive material or combination of conductive and insulating materials. In some aspects, the cell connection circuits 305a, 305b can be flex circuits configured to electrically couple with the positive and negative terminals of all battery cells so as to connect the cells in parallel, in series, or a combination of parallel and series connections. The cell connection circuits 305a, 305b can further be configured to connect the battery cells to a negative terminal 310a, 310b and a positive terminal 315a, 315b of each part 201a, 201b. Cell connection circuits 305a, 305b may be secured in place and/or protected by end cover walls 245a, 245b. In some aspects, end cover walls 245a, 245b may be composed of the same material as the cell cover walls 230a, 230b, and may be secured to the cell connection circuits 305a, 305b and/or other components of the housing 200 by heat staking.

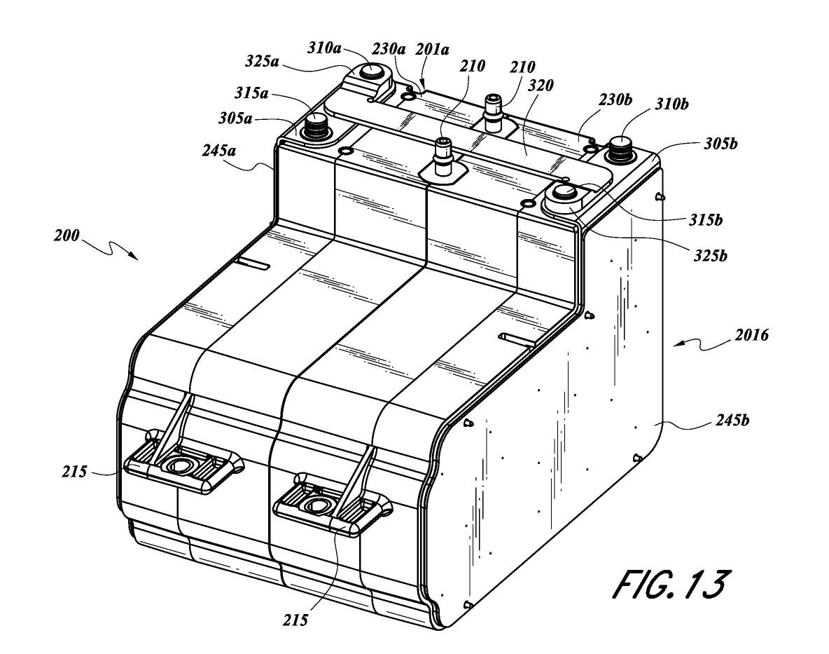

Various electrical connections may be made with the assembled housing 200 at the terminals 310a, 310b, 315a, 315b. For example, in some implementations it may be desired to produce electrical power at the voltage provided by the cells contained in a single housing part 201a, 201b, and the parts 201a, 201b may be connected in parallel with a negative or ground connection coupled to both negative terminals 310a, 310b and a positive connection coupled to both positive terminals 315a, 315b. In some implementations it may be desired to produce electrical power at twice the voltage provided by the cells contained in a single housing part 201a, 201b, and the parts 201a, 201b may be connected in series by electrically coupling either the left negative terminal 310a with the right positive terminal 315b or the left positive terminal 315a with the right negative terminal 310b. The uncoupled negative terminal 310a or 310b can then be connected to a negative or ground connection, and the uncoupled positive terminal 315a or 315b can be connected to a positive connection. Electrical connections external to a battery housing 200 will be discussed in greater detail below with reference to FIGS. 13-18.

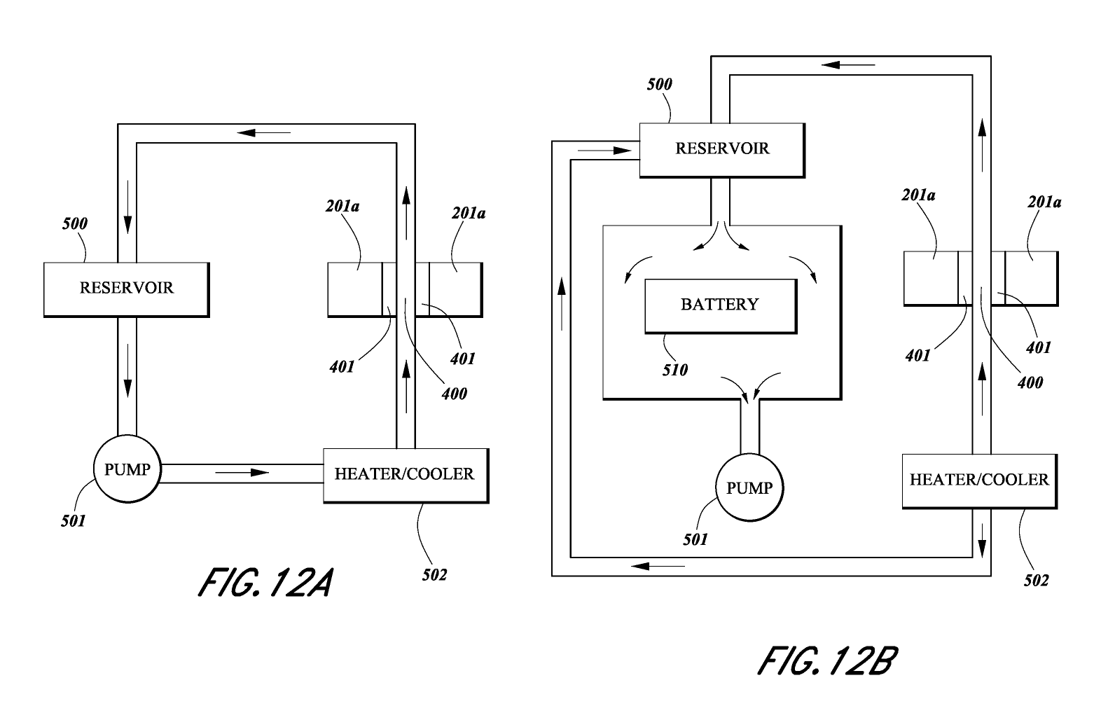

FIG. 12A schematically illustrates how the housing 200 may be implemented in an electric vehicle. As shown, liquid coolant may be pumped with a pump 501 through a heater and/or a cooler 502. The heater may raise the temperature of the coolant when necessary, for example, when the vehicle and/or the housing 200 is at a temperature lower than a desirable operating temperature. The heater may include an electric heater. The cooler may lower the temperature of the coolant when necessary, for example, when the vehicle and/or the housing 200 is at a temperature higher than a desirable operating temperature, such as due to a high ambient temperature, heat generated by battery cells 300, or heat generated by other components of the vehicle. The cooler may include a heat exchanger. The liquid coolant may then pass through the channel 400 and may heat and/or cool the cells as described above. The channel may be disposed in a housing comprising housing parts 201a and 201b as described above. The housing may house a low voltage battery system. The coolant may then flow through a reservoir 500 for excess coolant. It is noted that the components may be arranged in any order and are not limited to the configuration illustrated in FIG. 12A.

FIG. 12B schematically illustrates another implementation of the housing 200 in a battery cooling/heating system. As shown, the coolant may be circulated through the housing 200 (comprising housing parts 201a and 201b) as well as through a second housing that surrounds another battery 510. The battery 510 may include a high voltage battery system. It is noted that the components may be arranged in any order and are not limited to the configuration illustrated in FIG. 12B.

With reference to FIGS. 13-18, implementations for connection and operation of one or more battery modules will now be described. FIG. 13 depicts a battery housing 200 consistent with the embodiment depicted in FIG. 11. The housing 200 includes left part 201a and right part 201b. Left part 201a includes a cell cover wall 230a, end cover wall 245a, a bracket 215, and a cell connection circuit 305a configured to electrically connect one or more electrochemical cells (not shown) within the left housing part 201a to the left negative terminal 310a and the left positive terminal 315a. Similarly, right part 201b includes a cell cover wall 230b, end cover wall 245b, a bracket 215, and a cell connection circuit 305b configured to electrically connect one or more electrochemical cells (not shown) within the right housing part 201b to the right negative terminal 310b and the right positive terminal 315b. Coolant inlet/outlets 210 permit coolant to flow through an internal channel located between the cells of parts 201a and 201b.

As such, the housing 200 includes two sets of batteries that are cooled by an internal common channel. The electrochemical cells are thus positioned such that the non-electric terminal ends are facing inward and are in thermal contact with the channel and the electric terminal ends are facing outward and electrically connected by cell connection circuits 305a, 305b positioned on either side of the housing 200. The end cover walls 245a, 245b may physically protect and electrically insulate the connection circuits 305a, 305b. The cell connection circuits 305a, 305b may be configured to connect the cells in parallel or in series and provide a voltage difference between the positive terminals 315a, 315b and the negative terminals 310a, 310b. The cell connection circuits 305a, 305b may be disposed on opposite sides of, and parallel to, the common coolant channel. The common coolant channel may be oriented vertically within the housing 200 so as to facilitate fluid circulation through the channel and mitigate cavitation that may occur within the coolant in the channel.

The housing 200 depicted in FIG. 13 additionally includes a series bus bar 320 removably coupled to the left part 201a and the right part 201b of the housing so as to electrically connect the batteries in parts 201a, 201b in series. The series bus bar 320 includes a positive terminal connector 325b configured to receive and electrically couple the positive terminal 315b of the right housing part 201b to the series bus bar 320, and a negative terminal connector 325a configured to receive and electrically couple the negative terminal 310a of the left housing part 201a to the series bus bar 320. Accordingly, the open circuit voltage between the negative terminal 310b of the right housing part 201b and the positive terminal 315a of the left housing part 201a is equal to the sum of the open circuit voltage between terminals 310a and 315a and the open circuit voltage between terminals 310b and 315b. In implementations where housing parts 201a and 201b contain the same number and type of electrochemical cells, the open circuit voltage between terminals 310b and 315a can be double or approximately double the open circuit voltage between the terminals 310a and 315a, or 310b and 315b, of a single housing part 201a or 201b.

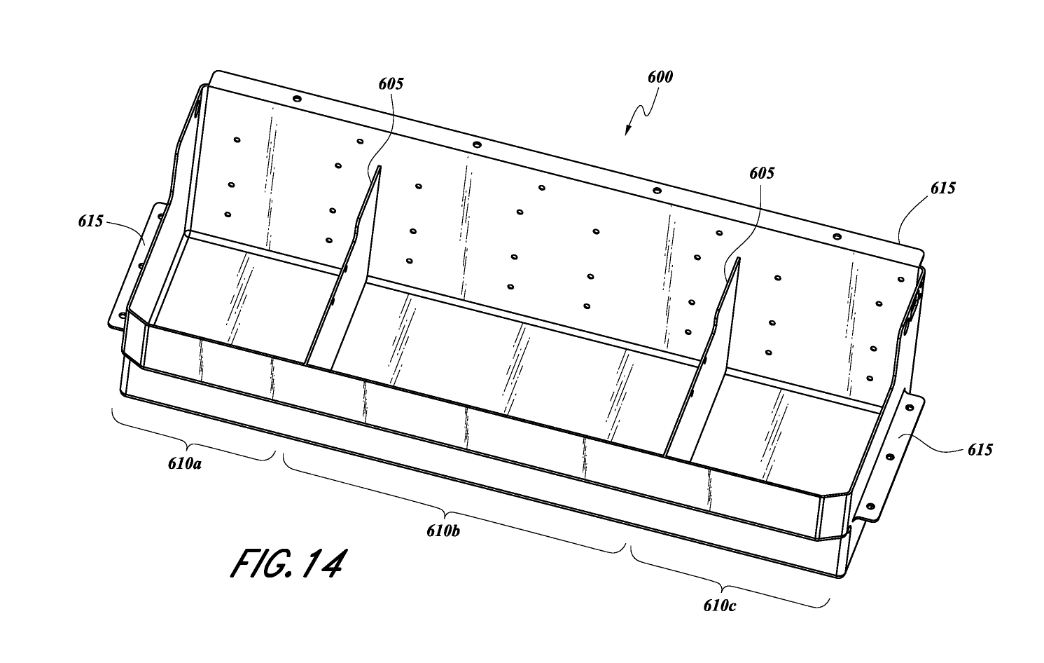

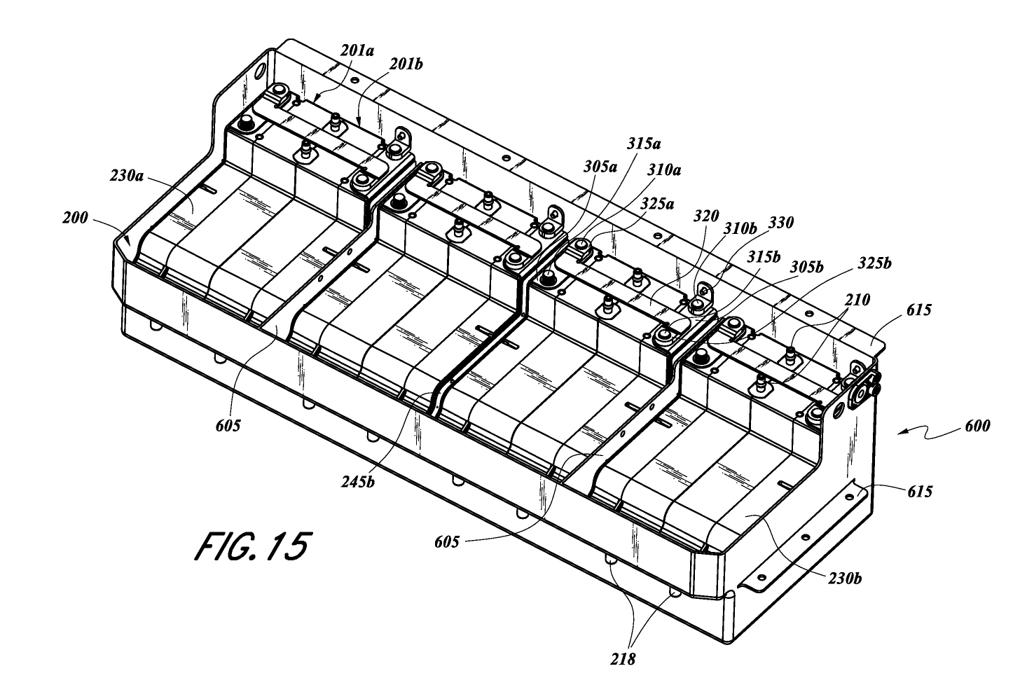

In some embodiments, a plurality of battery housings 200 can be combined to provide greater energy storage capacity and/or higher voltage. Referring now to FIGS. 14 and 15, a tray 600 may be configured to receive one or more battery housings 200. For example, the tray 600 depicted in FIGS. 14 and 15 is configured to receive four battery housings 200. In various embodiments, a tray 600 may be sized to receive a smaller or larger number of battery housings 200. Dividers 605 may divide the space within the tray 600 into compartments 610a, 610b, and 610c. The tray 600 may further include flanges 615 configured to support the tray 600, such as by mounting to one or more structural components within a vehicle. The tray 600 can be made of any suitably rigid material. For example, the tray 600 can be made of an electrically conductive material such as a metal (e.g., steel, aluminum, or the like), or an electrically insulating material such as a plastic.

FIG. 15 depicts the tray 600 containing four battery housings 200. In some embodiments, fewer than four battery housings 200 may be provided in tray 600. For example, if only two battery housings 200 are required, they may occupy center compartment 610b, while compartments 610a and 610c remain empty. In the embodiment depicted in FIG. 15, each of the battery housings 200 includes two housing parts 201a, 201b connected electrically in series by a series bus bar 320, as described above with reference to FIG. 13. The housings 200 can be connected electrically in parallel to provide additional energy storage without increasing voltage. For example, the negative terminals 310b of each of the right housing parts 201b can be grounded by connection to the tray 600, such as by grounding brackets 330. The tray 600 may be grounded by connection to other conductive structures of a vehicle at flanges 615.

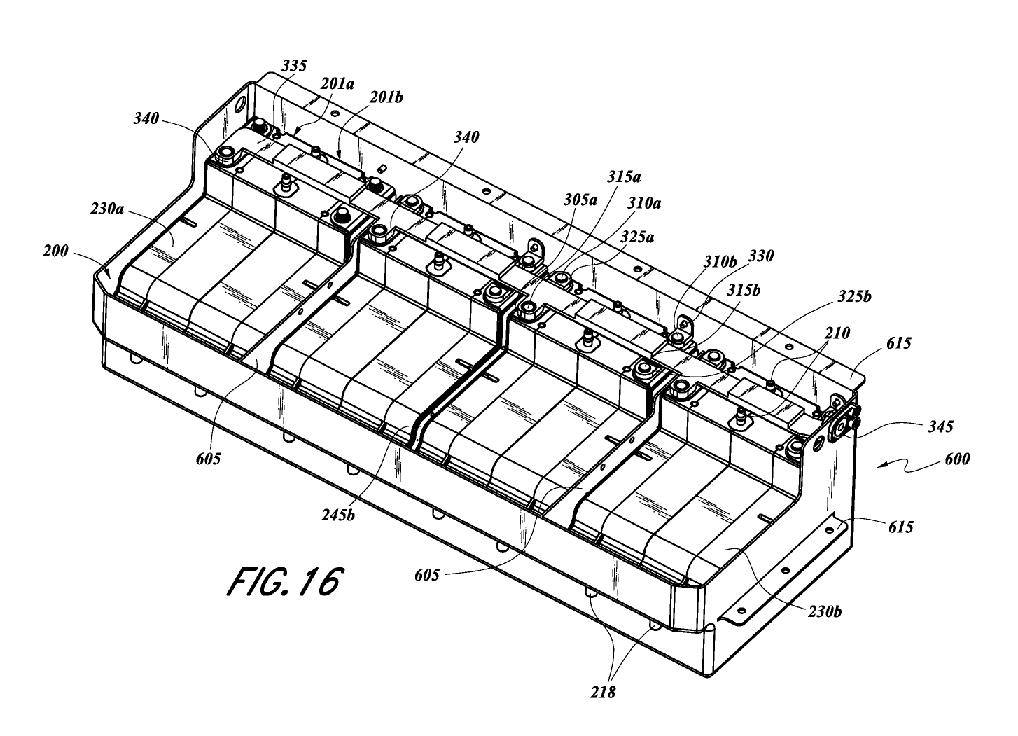

FIG. 16 depicts the tray 600 and battery housings 200 of FIG. 15, with a parallel bus bar 335 electrically connecting the four housings 200. The housings 200 may be connected in parallel by connecting the negative terminals 310b of each housing 200 to a common ground (e.g., the metal of the tray 600) and connecting the positive terminals 315a of each housing 200 to a common parallel bus bar 335. The parallel bus bar 335 may include one or more terminal connectors 340 having cavities and/or apertures sized and shaped to receive and electrically couple the positive terminals 315a of the left housing parts 201a to the parallel bus bar 335. The parallel bus bar 335 may be configured to be secured and removed from the terminals. The parallel bus bar 335 can be electrically connected to deliver electricity to one or more electrical systems of a vehicle. In some embodiments, a bus bar connector 345 may facilitate the connection to electrical systems of the vehicle by allowing the connection between the parallel bus bar 335 and external circuitry to pass through, and be electrically insulated from, the tray 600.

In some embodiments, a printed circuit board (PCB) and/or other circuitry (not shown) may be included, such as for monitoring the status and/or performance of the battery pack or one or more individual battery modules 200. For example, a PCB may be located in any suitable location adjacent to or near each battery module 200, such as on top of or below the parallel bus bar 335. The parallel bus bar 335 may support and/or secure the PCB, which may be attached in its location by connection to one or more of a battery module 200, parallel bus bar 335, series bus bar 320, or other structure of the battery pack. The PCB may be electrically connected to other circuitry of one or more battery modules 200, such as cell connection circuits 305a, 305b, one or more thermistors or other temperature sensors (not shown) located within the module 200, or other monitoring circuitry. Accordingly, each PCB may be used for monitoring and/or control of one or more battery modules 200. For example, a PCB may monitor an open circuit voltage of a battery module 200 or half module 201a, 201b, a voltage difference between components within a battery module 200 or half module 201a, 201b such as between two or more battery cells or groups of cells connected in series, a current flowing into or out of a battery module 200 or half module 201a, and/or temperature data obtained from temperature sensors (not shown) within a battery module 200.

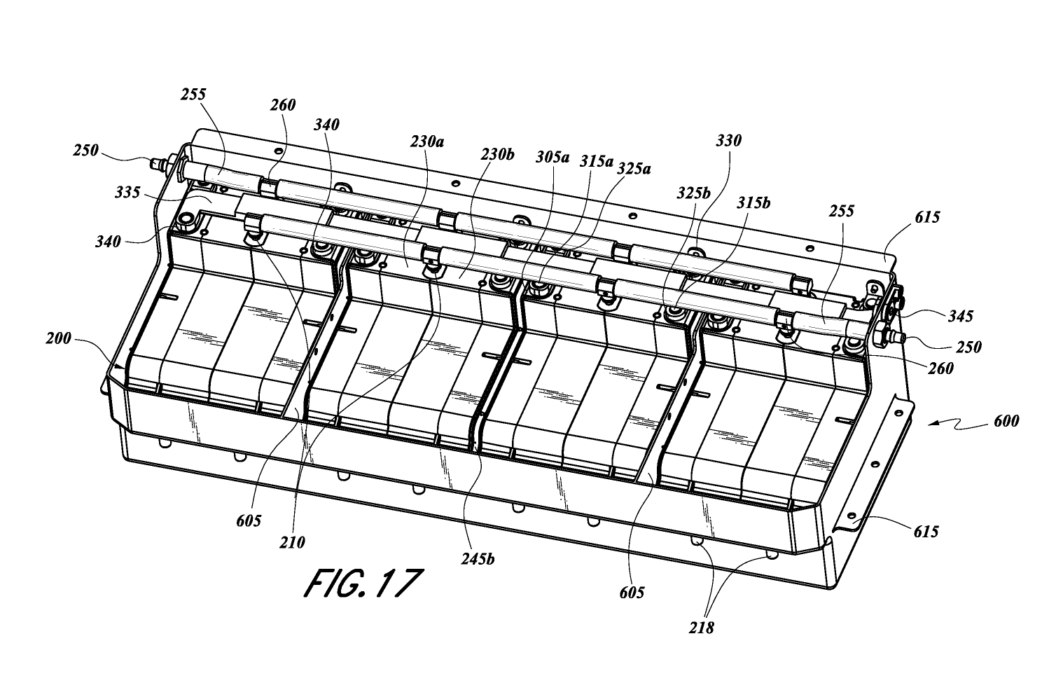

FIG. 17 depicts the electrically connected tray 600 and battery housings 200 of FIG. 16, with connections to a cooling system. Coolant supply and return conduits 255 may be provided to transfer coolant from an external cooling system (not shown) to the battery housings 200. Conduits 255 may be connected in fluid communication with tray coolant inlet/outlets 250 configured to allow coolant to pass through the tray 600 to the conduits 255 within the tray 600. Coolant inlet/outlet fittings 260 may allow coolant from the conduits 255 to pass into the battery housings 200 at coolant inlet/outlets 210. Cooling systems external to the tray 600 are described in greater detail above with reference to FIGS. 12A and 12B. Coolant flow paths and functionality within battery housings 200 are described in greater detail above with reference to FIGS. 2-10. As shown, the coolant flow paths may extend in a substantially straight line across the tray 600 and be spaced apart from the bottom-most surfaces of the tray such that the battery housings 200 may be easily inserted and removed from the receiving spaces in the tray 600.

As will be understood, the disclosed coolant path may provide a temperature control system that allows for a more uniform and parallel cooling/heating than other systems. The disclosed coolant pathway may also reduce the number of liquid connections in order to reduce the likelihood of leakage. For example, liquid coolant may be pumped into the inlet/outlet 250 on the left hand side of FIG. 17 at a first temperature. Thus, the liquid entering the common cooling channel of each the housings 200 at each of the rear fittings 260 may enter at about the first temperature. The liquid can then enter the cooling channel and exit the front fittings 210 at substantially the same second temperature.

In some aspects, the tray 600 is configured to be positioned in a vehicle in a direction that extends laterally with respect to a vehicle. That is to say, the tray 600 may be sized and shaped to extend along all or a portion of the width of a vehicle (e.g. in a direction extending from a front right wheel to a left front rear well). In some aspects, the tray 600 is configured to be secured an area that is easily accessible to a user or mechanic. For example, the tray may be located in a front or rear trunk area. In this way, the battery housings 200 may be easily accessed and removed and/or inserted into the tray as needed.

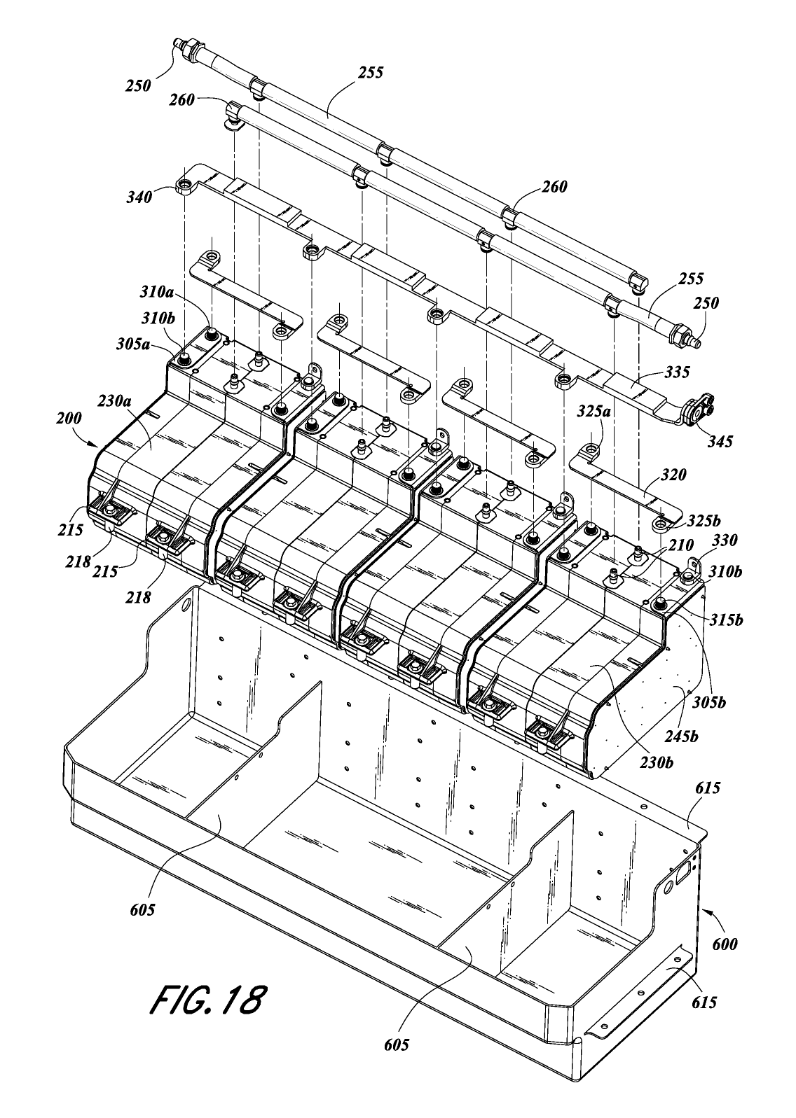

With reference to FIG. 18, example methods of assembling a battery system will now be described. FIG. 18 is an exploded view of the system depicted in FIG. 17, including a tray 600, battery housings 200, series bus bars 320, a parallel bus bar 335, and coolant conduits 255 configured to deliver coolant received at tray coolant inlet/outlets 250 to the coolant inlet/outlets 210 of the battery housings 200 at coolant inlet/outlet fittings 260. A tray 600 may be provided. Battery housings 200, including electrochemical cells (not shown) with electrical connections at negative terminals 310a, 310b and positive terminals 315a, 315b, may be placed into the tray 600. A negative terminal 310b of each housing 200 may then be secured and electrically coupled to the tray 600 by a grounding bracket 330. Series bus bars 320 may then be secured to each of the battery housings 200 to electrically couple a positive terminal 315b with a negative terminal 310a of each housing 200. A parallel bus bar 335 may then be secured across all housings 200 to connect the positive terminals 315a of the battery housings 200 in parallel. Finally, the coolant conduits 255 and coolant inlet/outlet fittings 260 may be coupled to the coolant inlet/outlets 210 of the housings 200, and may be connected to an external cooling system through tray coolant inlet/outlets 250. Coolant inlet/outlet fittings 260 can include any type of fluid connectors, such as valves, disconnects, dry break couplers, or other connectors providing switchable fluid communication between the coolant conduits 255 and coolant inlet/outlets 210.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components may be present in an actual embodiment (assuming that the functionality of the depicted circuits is not adversely affected).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the implementations are not limited to the precise configuration and components illustrated above. Various modifications, changes, and variations may be made in the arrangement, operation, and details of the methods and apparatus described above without departing from the scope of the implementations.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

What is claimed is:

1. A modular low voltage battery pack for a vehicle comprising:
a tray configured to receive a plurality of battery housings, the tray having a bottom surface for supporting the plurality of battery housings from below;
a liquid path spaced away from the bottom surface and above the battery housings when the housings are inserted into the tray, the liquid path having an inlet flow path with a plurality of outlets coupleable to an inlet in at least one flow path in the plurality of battery housings and an outlet flow path with a plurality of inlets coupleable to an outlet in the at least one flow path in the plurality of battery housings; and
a circuit configured to provide a voltage difference between the tray and a positive terminal.

2. The battery pack of claim 1, wherein the tray comprises a plurality of receiving spaces separated by upwardly extending walls, each receiving space configured to receive one or more battery housings.

3. The battery pack of claim 1, wherein the liquid path comprises a substantially straight conduit extending from the inlet flow path and terminating at a distalmost outlet coupleable to a distalmost inlet in at least one flow path in the plurality of battery housings.

4. The battery pack of claim 1, wherein the liquid path comprises a substantially straight conduit extending from the proximalmost inlet flow path and terminating at a proximalmost outlet coupleable to a proximalmost outlet in at least one flow path in the plurality of battery housings.

5. The battery pack of claim 1, wherein the circuit comprises a parallel bus bar configured to electrically connect at least two terminals on the top side of each of the battery housings.

6. The battery pack of claim 1, further comprising the plurality of battery housings disposed within the tray.

7. The battery pack of claim 6, wherein each battery housing of the plurality of battery housings comprises a common flow channel in thermal contact with non-electrically conductive portions of two sets of electrochemical cells.

8. The battery pack of claim 7, wherein the common flow channel extends in a direction that is normal to the bottom surface of the tray.

9. The battery pack of claim 7, wherein the electrochemical cells comprise cylindrical battery cells that are oriented normal to the flow channels within each battery housing.

10. The battery pack of claim 7, wherein the electrochemical cells in each housing are connected by two circuits on opposite sides of the flow channel, the circuits being positioned parallel to the flow channel.

11. A method of adding a battery module to a modular low voltage battery pack of a vehicle, the method comprising:
disconnecting a bus bar from a terminal post of a first battery module secured within a tray of the battery pack;
uncoupling a coolant conduit from a coolant inlet of the first battery module;
placing a second battery module into the tray;
electrically connecting the bus bar to the terminal post of the first battery module and a terminal post of the second battery module; and
coupling the coolant conduit to the coolant inlet of the first battery module and a coolant inlet of the second battery module,
wherein adding the second battery module to the battery pack increases the energy storage capacity of the battery pack.

12. The method of claim 11, wherein first battery module and the second battery module are electrically connected in parallel.

13. The method of claim 11, wherein adding the second battery module to the battery pack does not increase the maximum open circuit voltage of the battery pack.

14. The method of claim 11, further comprising:
placing a third battery module into the tray;
securing the third battery module to the tray;
electrically connecting the bus bar to the terminal post of the third battery module; and
coupling the coolant conduit to the coolant inlet of the third battery module.

15. A modular low voltage battery pack for a vehicle comprising:
at least one battery module having a positive terminal post, a coolant inlet, and a coolant outlet;
circuitry configured to electrically connect the positive terminal post to a low voltage vehicle load;
a cooling system configured to supply coolant to the at least one battery module at the coolant inlet and receive coolant from the at least one battery module at the coolant outlet, the cooling system comprising at least one conduit; and
a tray secured to and at least partially surrounding the at least one battery module;
wherein the tray is configured to receive at least one additional battery module to increase the energy storage capacity of the battery pack.

16. The battery pack of claim 15, wherein the circuitry comprises a conductive metallic bus bar configured to be removably electrically connected to one or more positive terminal posts.

17. The battery pack of claim 16, wherein the bus bar comprises a plurality of apertures, each aperture sized and shaped to receive the positive terminal post of a battery module.

18. The battery pack of claim 15, wherein each battery module further comprises a negative terminal post, at least a portion of the tray comprises an electrically conductive metal, and the negative terminal post of each of the plurality of battery modules is electrically connected to the electrically conductive metal.

19. The battery pack of claim 15, wherein the cooling system is configured to supply coolant to the at least one additional battery module at a coolant inlet and receive coolant from the at least one additional battery module at a coolant outlet.

20. The battery pack of claim 19, wherein the cooling system comprises:
a coolant supply conduit having a plurality of fluid supply connectors, each fluid supply connector configured to be removably connected to a coolant inlet; and
a coolant return conduit having a plurality of fluid return connectors, each fluid return connector configured to be removably connected to a coolant outlet;
wherein each fluid supply connector is configured to prevent coolant from flowing out of the coolant supply conduit while not connected to a coolant inlet, and wherein each fluid return connector is configured to prevent coolant from flowing out of the coolant return conduit while not connected to a coolant outlet.
